(19) United States
(12) Patent Application Publication
(10) Pub. No.: US 2008/0318455 A1
(43) Pub. Date: Dec. 25, 2008

(54) BACKPLANE CONNECTOR WITH HIGH DENSITY BROADSIDE DIFFERENTIAL SIGNALING CONDUCTORS

(75) Inventors: Brian S. Beaman, Apex, NC (US); William L. Brodsky, Binghamton, NY (US); Joseph C. Diepenbrock, Raleigh, NC (US); Mark K. Hoffmeyer, Rochester, MN (US); Amanda E. Mikhail, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/767,890

(22) Filed: Jun. 25, 2007

(51) Int. Cl. H01R 4/66

(52) U.S. Cl. 439/108

(57) ABSTRACT

Embodiments of the present invention address deficiencies of the art in respect to backplane connectivity and provide a backplane connector for high density broadside differential signaling. In an embodiment of the invention, a backplane connector can be provided. The backplane connector can include a signal header assembly and a signal receptacle assembly. The signal header assembly can include pairs of differential signaling conductors arranged in columns for broadside signaling. Comparably, the signal receptacle assembly can include pairs of conductor receptacles arranged in columns to receive corresponding ones of the pairs of the differential signaling conductors. Finally, a surface mount (SMT) lead can be provided for each of the conductor receptacles and each of the signaling conductors

### BACKGROUND OF THE INVENTION

1. Field of the Invention

The present invention relates to the field of computer circuit connectivity and more particular to backplane connectors for daughter card connectivity.

2. Description of the Related Art

An electronic computing system often includes components mounted on printed circuit cards. Backplane systems, namely daughtercards and backplane boards, can be interconnected to transfer power and data signals throughout a computing system. A typical connector assembly for backplane systems includes a backplane connector attached respectively to each of a motherboard and daughtercard. The backplane connectors can be joined to one another to electrically connect the motherboard and the daughtercard. As such, multiple daughter cards can be connected through a single backplane card and can be oriented at right angles to the backplane card.

Backplanes and daughter cards have been used in computer systems for nearly fifty years and are currently used in most modern computer systems including blade servers. As a result, in order to meet the ongoing demand for higher speed signaling and increased systems performance, backplane connector designs have evolved to increase the density of the electrical connections and to improve the electrical performance properties of the metal contact structures of the backplane connector. Most backplane connector designs derive from an open pin field configuration. In an open pin field configuration, square shaped metal contacts can be arranged in a rectangular grid with equal spacing between the contacts. By adding ground planes in between the columns of signal contacts, the electrical coupling, e.g. cross talk, between columns of contacts can be significantly reduced and signal bandwidth increased.

As yet a further enhancement, ground planes can be separated and matched to individual signal contacts resulting in increased contact density and improved signal bandwidth. In the latter connector configuration, embodied by the Ventura (™) product manufactured by Amphenol Corporation of Nashua, N.H. United States of America, both increased performance and increased signal contact density can be achieved through the use of signal and ground contacts with leads designed for surface mount attachment to printed circuit cards. Even still, several alternate approaches to achieving increased signal bandwidth have been proposed.

In one alternative approach, an edge coupled configuration similar to an open pin field construction can be provided, the main difference being in the rectangular or blade shaped signal pins and the close spacing between blades at the narrow surface versus increased spacing between the wide surface of the blades. Conversely, the I-Trac (™) Backplane Connector System arrangement manufactured by Molex Incorporated of Lisle, Ill., United States of America, provides for a stripline configuration of opposing blade shaped signal pins arranged in signaling columns for broadside, differential signaling. Signal density is sacrificed in the I-Trac (™) arrangement however, because the different columns of differential signaling conductors are separated by a greater amount of space in order to reduce cross talk.

Notwithstanding the foregoing efforts, the advancement of computing technologies applies ever increasing pressure on the performance parameters of backplane connectors. Accordingly, computer engineers continue to strive to identify new arrangements intended to increase signal density as compared to known backplane connector systems.

### BRIEF SUMMARY OF THE INVENTION

Embodiments of the present invention address deficiencies of the art in respect to backplane connectivity and provide a novel and non-obvious backplane connector for high density broadside differential signaling. In an embodiment of the invention, a backplane connector can be provided. The backplane connector can include a signal header assembly and a signal receptacle assembly. The signal header assembly can include pairs of differential signaling conductors arranged in columns for broadside signaling. Comparably, the signal receptacle assembly can include pairs of conductor receptacles arranged in columns to receive corresponding ones of the pairs of the differential signaling conductors. Finally, a surface mount (SMT) lead can be provided for each of the conductor receptacles and each of the signaling conductors.

In one aspect of the embodiment, each column of differential signaling conductors can include two matched signal header wafers, and each column of conductor receptacles can include two matched signal receptacle wafers. Optionally, metal foil can be disposed between the signal receptacle wafers and coupled to ground to reduce cross-talk between the differential signaling pairs of signaling conductors and signaling receptacles. As yet another option, insulative plastic can be disposed about the signaling conductors in each of the signal header wafers and conductive plastic can be disposed about a housing for each of the signal header wafers. Likewise, insulative plastic can be disposed about the conductor receptacles in each of the signal receptacle wafers and conductive plastic can be disposed about a housing for each of the signal receptacle wafers.

In another aspect of the embodiment, each of the columns of the signal header assembly can include a single grounded pair of ground conductors. Alternatively, one fourth of the columns of the signal header assembly can include all grounded pairs of ground conductors and another column, and one fourth of the columns of the signal header assembly can include alternating pairs of signal conductors and ground conductors. As yet another alternative, every other one of the columns of the signal header assembly can include all grounded pairs of ground conductors. Finally, as even yet another alternative, each of the columns of the signal header assembly can include alternating pairs of signal conductors and ground conductors.

In consequence of the arrangement of the backplane connector of the embodiment, including the SMT leads, packaging density in terms of contacts/inch can be improved over the I-Trac (™) system and broadside coupled differential signal pairs can be applied to demonstrate better electrical performance than backplane connectors that use edge coupled differential signal pairs. In this regard, the electromagnetic fields of the embodiment enjoy a wider surface area to couple energy between the two signal conductors and less electromagnetic energy is radiated outside of the signal pair. The broadside coupled construction also demonstrates less skew within each of the differential signal pairs since each of the pairs is arranged in the same row and the path length of the metal conductors in a right angle connector would be the same physical length.

As a further benefit of the broadside coupled differential signal pair construction, reduced susceptibility to common mode noise between differential signal pairs is provided. Specifically, coupled noise results from the electromagnetic energy that is radiated outside of the signal pair and coupled to an adjacent signal pair. The symmetric arrangement between the adjacent signal pairs within a column results in equal coupled noise transfer for each of the adjacent signal conductors since the distance is the same. If the coupled noise on each of the signal conductors in a differential pair is the same, the resulting effect is an effective cancellation of the energy on the differential signal pair. However, the common mode noise transferred between adjacent signal pairs in the same row would be different since the relative distances are different.

Finally, the high speed electrical performance of the backplane connector of the embodiment can be optimized by selectively tying pairs of conductors to ground. The addition of the ground conductors provides improved shielding for the differential signal conductors. Various configurations of ground conductors can be used to optimize the high speed electrical performance for a given system application. However, the addition of the ground conductors effectively reduces the signal density of the connector.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a perspective view of a signal header assembly for a backplane connector configured for high density, broadside, differential signaling;

FIG. 2 is a perspective view of a signal receptacle assembly for a backplane connector configured for high density, broadside, differential signaling;

FIGS. 3A and 3B, taken together, are a perspective view of a signal header wafer and corresponding signal receptacle wafer for a backplane connector configured for high density, broadside, differential signaling;

FIG. 4 is a perspective view of the signal header wafer and corresponding signal receptacle wafer of FIGS. 3A and 3B, arranged for coupling to one another;

FIG. 5 is a diagram of different conductor assignments for signal and ground for application to the signal header assembly of FIG. 1;

FIG. 6 is a perspective view of a signal header wafer configured with metal foil for a backplane connector configured for high density, broadside, differential signaling; and,

FIGS. 7 and 8, taken together, are a perspective view of a signal header wafer and corresponding signal receptacle wafer for a backplane connector configured for high density, broadside, differential signaling with insulative plastic separating the conductors of the signal header wafer and the receptacle contacts of the signal receptacle wafer and with conductive plastic applied to the wafer housing.

### DETAILED DESCRIPTION OF THE INVENTION

Embodiments of the present invention provide a backplane connector for broadside differential signaling. In accordance with an embodiment of the present invention, a backplane connector can be configured with multiple parallel striplines of conductors, each parallel pair of striplines forming a signaling column, each signaling column being spaced from one another to maximize signal density. The conductive pairs in each signaling column can include signal contacts to enable broadside, differential signaling. Also, an SMT lead can be provided for each of the conductor receptacles and each of the signaling conductors. Optionally, selective ones of the conductive pairs in each signaling column can be coupled to ground to improve shielding for the differential signal contacts. As yet a further option, metal foil can be disposed between each of the signaling rows to improve high speed electrical performance. Finally, as even yet a further option, an insulating plastic material can separate the conductors, while a conductive plastic can house each stripline in order to provide additional shielding between the conductors to minimize cross talk.

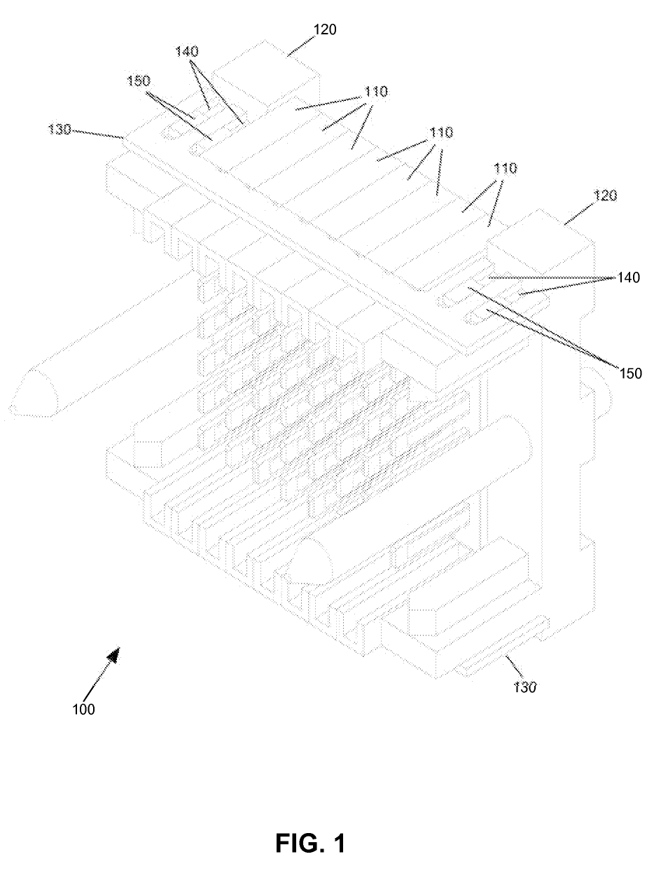

The preferred embodiment of backplane connector is comprised of a signal header assembly and a signal receptacle assembly. The signal header assembly can be attached to a backplane circuit card and the signal receptacle assembly can be attached to a daughter card. In illustration, FIG. 1 provides a perspective view of a signal header assembly 100 for a backplane connector configured for high density, broadside, differential signaling. As shown in FIG. 1, the signal header assembly 100 can include multiple signal header wafers 110 and guide blocks 120 on each end. The guide blocks 120 and signal header wafers 110 can be grouped together using a set of metal stiffeners 130. The metal stiffeners 130 can include slotted features 140 that correspond to elongated raised features or ribs 150 on the signal header wafers 110 and guide blocks 120.

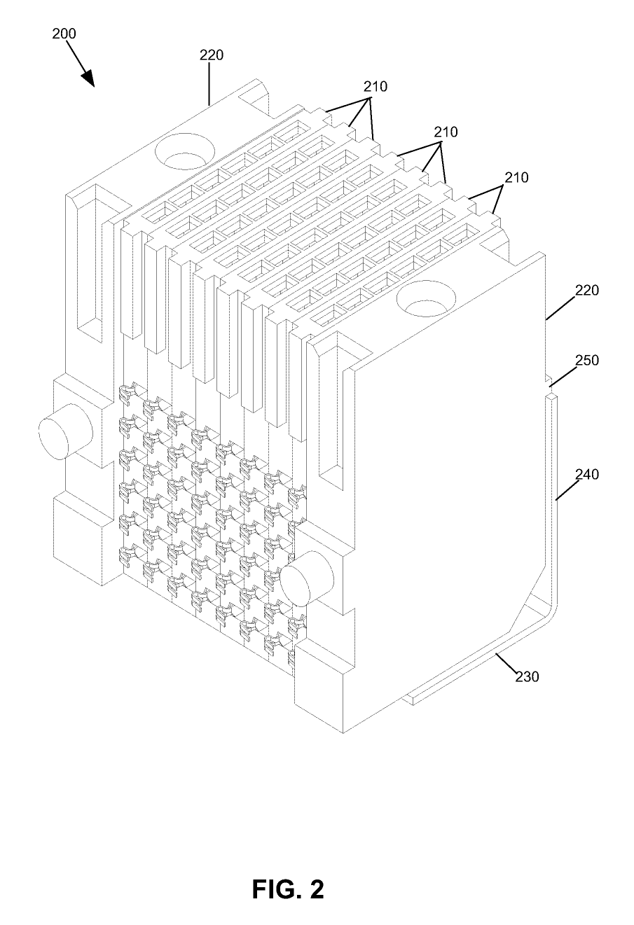

By comparison, FIG. 2 is a perspective view of a signal receptacle assembly 200 for a backplane connector configured for high density, broadside, differential signaling. The signal receptacle assembly 200 can include multiple signal receptacle wafers 210 and guide blocks 220 on each end. The guide blocks 220 and signal receptacle wafers 210 can be grouped together using a set of metal stiffeners 230. As in the case of the signal header assembly 100 of FIG. 1, the metal stiffeners 230 of the signal receptacle assembly 200 of FIG. 2 can include slotted features 240 that correspond to elongated raised features or ribs 250 on the signal receptacle wafers 210 and guide blocks 220.

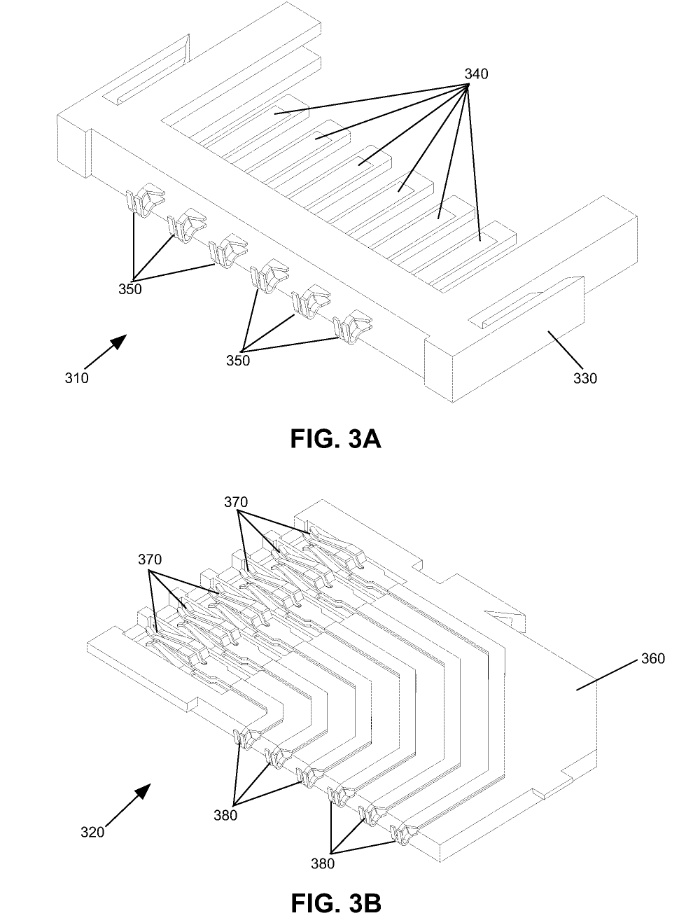

FIGS. 3A and 3B, taken together, are a perspective view of a signal header wafer 310 and corresponding signal receptacle wafer 320 for a backplane connector configured for high density, broadside, differential signaling. The signal header wafer 310 of FIG. 3A can include a plastic housing 330 and signal contacts 340 with leads 350 that are designed for SMT attachment to a printed circuit card. The signal contacts 340 are typically made from a copper alloy and are plated with nickel and gold to provide a reliable separable contact interface. Likewise, the signal receptacle wafer 320 can include a plastic housing 360 and signal contacts 370 with leads 380 that are designed for surface mount (SMT) attachment to a printed circuit card. The signal contacts 370 are typically made from a copper alloy and are plated with nickel and gold to provide a reliable separable contact interface.

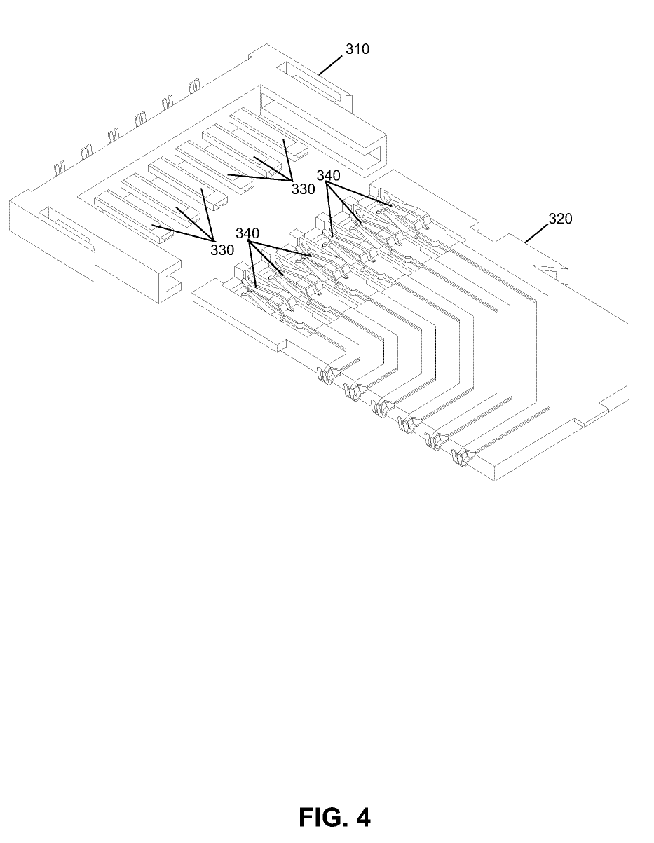

As shown in FIG. 4, the signal header wafer 310 and corresponding signal receptacle wafer 320 of FIGS. 3A and 3B can be arranged for coupling to one another. The signal header wafer 310 can include a bank of signal conductors 340, whereas the signal receptacle wafer 320 can include a corresponding bank of signal receptacle contacts 370. The signal conductors 340 on the top side of the signal header wafer 310 and the signal receptacle contacts 370 on the top side of the signal receptacle wafer 320 can be matched with a mirror image set of signal conductors 340 and corresponding signal receptacle contacts 370 on the bottom side of the signal header wafer 310 and the signal receptacle wafer 320. The mirror imaged configuration can provide an optimum geometry for broadside differential coupling.

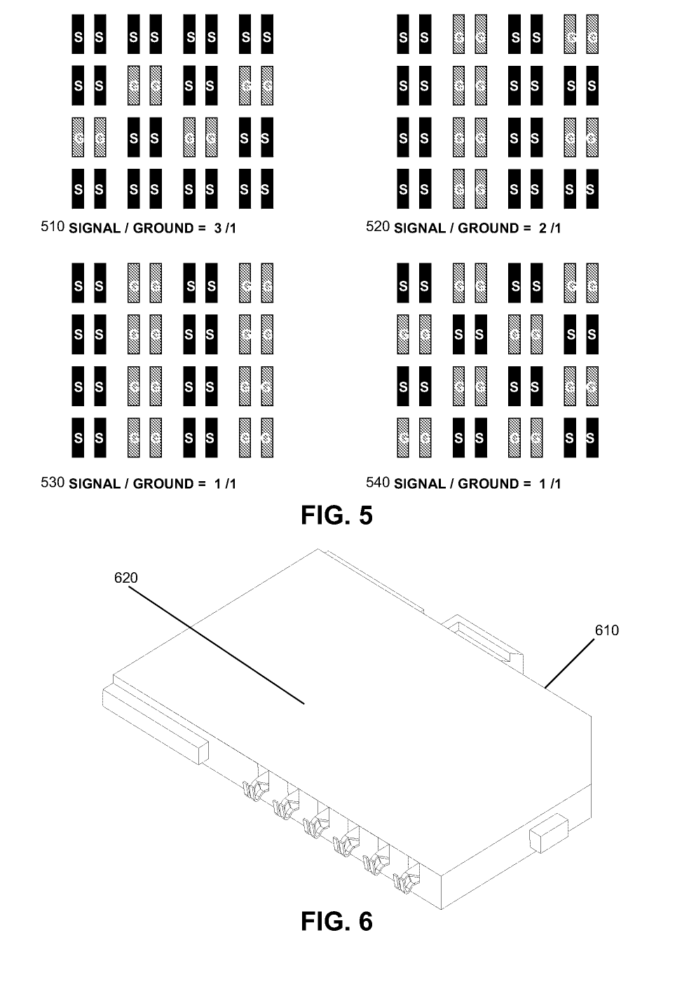

The high speed electrical performance of the backplane connector of FIGS. 1 and 2, can be optimized by selectively tying different conductors to ground. The addition of the ground conductors provides improved shielding for the differential signal conductors. Various configurations of ground conductors can be used to optimize the high speed electrical performance for a given system application as shown in FIG. 5. For example, a 3-1 signal to ground ratio arrangement 510 is shown in FIG. 5, compared to a 2-1 signal to ground ratio arrangement 520. Two different variants of a 1-1 signal to ground ratio arrangement 530, 540 further are shown in FIG. 5. In the first variant, a 1-1 signal to ground ratio arrangement 530 can provide alternating signaling and grounded columns, while in the second variant, a 1-1 signal to ground ratio arrangement 540 can provide alternating pairs of signaling pins and grounding pins in each column offset from one another from column to column.

As an optional enhancement, a thin layer of metal foil can be applied to the surface between signal receptacle connector wafers. Specifically, FIG. 6 is a perspective view of a signal header wafer configured with metal foil for a backplane connector configured for high density, broadside, differential signaling. As shown in FIG. 6, a thin, metallic foil layer 620 can be placed in between signal receptacle wafers 610. In consequence, cross-talk can be reduced. As yet an additional enhancement, a two stage insert molding process can be applied during construction of the signal conductor header and the signal receptacle. In the first stage, the housed interior of the header and receptacle can be molded using an insulative plastic material to separate the copper signal conductors. In a second stage, the housing itself can be molded using a conductive plastic material. The conductive plastic material can provide additional shielding between the differential signal conductors to minimize cross talk.

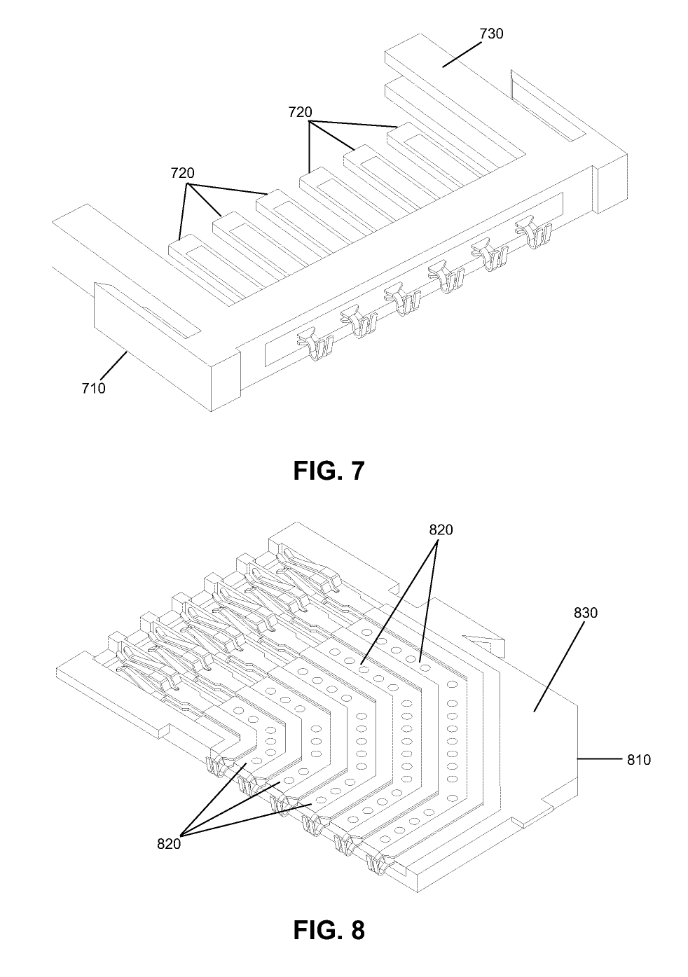

In illustration, FIGS. 7 and 8, taken together, are a perspective view of a signal header wafer and corresponding signal receptacle wafer for a backplane connector configured for high density, broadside, differential signaling with insulative plastic insulating the conductors of the signal header wafer and the receptacles of the signal receptacle wafer and with conductive plastic applied to the wafer housing. The signal header wafer 710 shown in FIG. 7 and the signal receptacle wafer 810 shown in FIG. 8 both use plastic housings made from a two stage molding process with insulative plastic 720, 820 and conductive plastic 730, 830. The conductive plastic material 730, 830 would be connected to logic ground through the metal stiffener and guide block hardware (not shown) that is attached to ground pads on the circuit card.

Further benefits of the preferred embodiment of the backplane connector include improved capability for card assembly processing. The differential signal header and receptacle wafer designs can use two thirds the total number of SMT leads as compared to conventional backplane connector designs. Fewer SMT leads translate to improved SMT lead co-planarity control and solder assembly yields. Also, the elimination of the metal shielding in each of the receptacle wafers can improve the resolution for X-RAY inspection capability for the solder joints for process control purposes. Elimination of the metal shielding and the redundant SMT ground leads has an additional benefit of eliminating the problem in electrical testing of verifying the continuity of both of the SMT ground leads.

We claim:

1. A backplane connector comprising:
a signal header assembly and a signal receptacle assembly;
the signal header assembly comprising a plurality of pairs of differential signaling conductors arranged in columns for broadside signaling;
the signal receptacle assembly comprising a plurality of pairs of conductor receptacles arranged in columns to receive corresponding ones of the pairs of the differential signaling conductors; and,
a surface mount (SMT) lead for each of the conductor receptacles and each of the signaling conductors.

2. The backplane connector of claim 1, wherein each column of differential signaling conductors comprises two matched signal header wafers, and wherein each column of conductor receptacles comprises two matched signal receptacle wafers.

3. The backplane connector of claim 2, further comprising metal foil disposed between the signal receptacle wafers.

4. The backplane connector of claim 2, further comprising:
insulative plastic disposed about the signaling conductors in each of the signal header wafers and conductive plastic disposed about a housing for each of the signal header wafers; and,
insulative plastic disposed about the conductor receptacles in each of the signal receptacle wafers and conductive plastic disposed about a housing for each of the signal receptacle wafers.

5. The backplane connector of claim 1, wherein each of the columns of the signal header assembly comprises a single grounded pair of ground conductors.

6. The backplane connector of claim 1, wherein one fourth of the columns of the signal header assembly comprises all grounded pairs of ground conductors and another column, and one forth of the columns of the signal header assembly comprises alternating pairs of signal conductors and ground conductors.

7. The backplane connector of claim 1, wherein every other one of the columns of the signal header assembly comprises all grounded pairs of ground conductors.

8. The backplane connector of claim 1, wherein each of the columns of the signal header assembly comprises alternating pairs of signal conductors and ground conductors.
